(19) United States
(12) Patent Application Publication
(10) Pub. No.: US 2006/0045811 A1
(43) Pub. Date: Mar. 2, 2006

(54) Sample-introducing apparatus and method for ICP analysis

(75) Inventor: Naoki Sugiyama, Tokyo (JP)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 11/190,440

(22) Filed: Jul. 27, 2005

(30) Foreign Application Priority Data
Aug. 30, 2004 (JP) 2004-249668

(51) Int. Cl. B01L 3/00

(52) U.S. Cl. 422/100

(57) ABSTRACT

To provide an ICP analytical apparatus which does not suck air at a change of sample solution, thereby not resulting in a stop of self-priming and in a long time fluctuation of an internal standard signal. The ICP analytical apparatus includes a controller for automatically stopping carrier gas or automatically reducing the flow rate of carrier gas at a change of sample solution.

### FIELD OF THE INVENTION

The present invention relates to an ICP analytical apparatus using an inductively-coupled plasma mass spectrometry (ICP-MS), an inductively-coupled plasma optical emission spectrometry (ICP-OES), or the like. In particular, the present invention relates to a sample-introducing apparatus and method of an ICP analytical apparatus, capable of stabilizing a solution sent to a nebulizer at a change of sample.

### BRIEF DESCRIPTION OF THE DRAWING

FIG. 1 schematically depicts a sample-introducing apparatus for ICP analysis using a self-priming nebulizer.

FIG. 2 schematically depicts a sample-introducing apparatus for ICP analysis where an internal standard is added online using a pump.

FIG. 3 is a flow chart partially showing a control sequence performed when a self-priming nebulizer is used and combined with an auto-sampler.

FIG. 4 is a graph showing a difference in signal change between stopping and not stopping the pump in the case of adding an internal standard online.

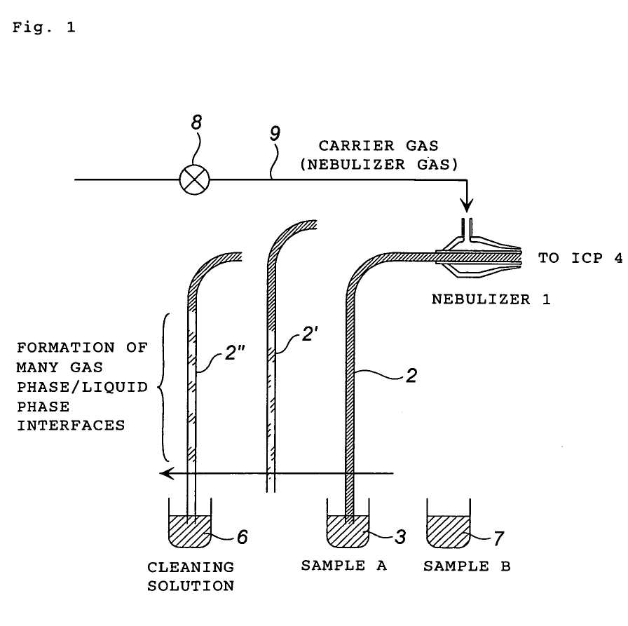

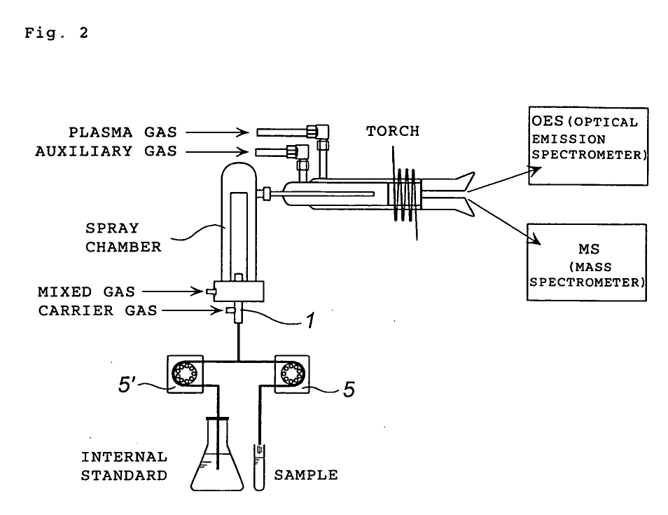

The ICP analytical apparatus is configured so as to introduce a sample solution to a nebulizer to atomize it, and then send the atomized solution into a plasma torch, in order to make identification or quantitative determination of trace amounts of impurity elements in the sample solution. FIG. 1 shows a typical configuration of the sample-introducing portion. When carrier gas such as argon is conveyed to the nebulizer 1, sample 3 is sucked into the nebulizer 1 by a negative pressure generated at the end of the nebulizer 1. The sucked sample is atomized by the nebulizer 1, and sample aerosol produced by this is introduced from the spray chamber to the plasma torch 4. Then, the sample aerosol is ionized by high-temperature plasma, and is detected by the following optical emission spectrometer (OES) or mass spectrometer (MS) not shown in the figure. When the nebulizer 1 itself has no function of sucking a sample solution, or an internal standard is added online, a pump 5 is used as shown in FIG. 2, by which a sample is sent into the nebulizer 1. And 5′ denotes a pump used to add an internal standard.

When some samples are analyzed by means of ICP analysis, in a self-priming system shown in FIG. 1, for example, the sample tube 2 is pulled up (2′ denotes this state) after the measurement of sample 3, and then dipped in the vessel containing a cleaning solution 6 (2″ denotes this state). Then, the sample tube 2 is pulled up again, and dipped in the vessel containing the next sample 7 to make the measurement of the sample 7. Such a process is repeated until the measurement of all the samples is finished.

In JP-A 8-201294 it is disclosed that a nebulizer 1 having two nozzles 4, 5 is used, and a tube 6 extending from one of the nozzles is used for the measurement of sample solutions 81 to 84, and a tube 7 extending from the other one is used for a cleaning solution vessel 9. It is proposed that the tube 6 is moved among sample solutions 81 to 84 while the pinch valves 61, 71 provided on the tubes respectively are opened and closed alternately, and thereby the number of moving operations and moving time of the tube are reduced.

In JP-A 2000-100374 it is disclosed that a plurality of nebulizers 14 are connected to a plasma torch 4 via a change-over valve 3, and carrier gas is changed to make ICP analysis. Furthermore, in JP-A 2001-311736, an auto-sampler for an ICP analytical apparatus is disclosed, and it is also disclosed that a capillary tube 2 connected to a nebulizer 1 is fixed and sample vessels 3 are moved horizontally and vertically toward the capillary tube so that auto-sampling is made using a shorter capillary tube.

### SUMMARY OF THE INVENTION

When samples are changed and measured in a self-priming system as described above, there is a problem that air is sucked into the sample tube when it is moved from a sample to another sample, and thereby self-priming stops and the measurement becomes impossible. According to the inventor's knowledge, this problem is caused by that as a result of sucking air into a sample tube having a small diameter (e.g., ø<0.3 mm), many interfaces between liquid phases and gas phases are formed, and the resistance to the self-priming power of the nebulizer becomes too large. JP-A 2001-311736 partially addresses such a problem, but since the moving time is not reduced only by shortening the length of the capillary tube to make the flow resistance smaller, the problem that sacking air forms interfaces between liquid phases and gas phases, thereby stopping self-priming has not been solved.

On the other hand, it is also one approach to use a valve to close a tube when the tube is moved as shown in JP-A 8-201294 and JP-A 2000-100374, and it is described in JP-A 8-201294 that this approach prevents the plasma from being destabilized due to sucking of air. However, when a pinch valve is used as shown in JP-A 8-201294, the sample tube deforms and an influence exerted on the flow rate by the deformation can not be ignored. Furthermore, in JP-A 2000-100374, it is defined per se that the same sample is measured by changing different carrier gases, while nothing is disclosed with regard to changing samples themselves.

In addition, it has been found that there is a problem that in a case like FIG. 2 where an internal standard is added to a sample by using a pump, the signal of the internal standard fluctuates due to sucking of air at a change of sample. In this case, it does not happen to stop sucking of a sample, while the analysis should be waited until the signal is stabilized again. This deteriorates the throughput of an ICP analytical apparatus, and leads to a waste of energy before the stabilization.

It is therefore a purpose of the present invention to address the problem that in an ICP analytical apparatus, at a change from one sample to another sample, a solution being sent is destabilized due to sucking of air, and thereby self-priming stops. It is another purpose of the present invention to address the problem that when a sample is sucked along with an internal standard by a pump, the signal is destabilized due to sucking of air. In addition, it is also a purpose of the present invention to provide an auto-sampler for addressing these problems.

The invention provides a sample-introducing apparatus for ICP analysis comprising a sample tube for conveying a sample solution, and a nebulizer connected to the sample tube and formed so as to suck a sample solution by means of carrier gas supplied, the sample-introducing apparatus for ICP analysis further comprising a controller for automatically stopping carrier gas or automatically reducing the flow rate of carrier gas at a change of sample solution.

The invention provides another sample-introducing apparatus for ICP analysis comprising a sample tube for conveying a sample solution, a nebulizer connected to said sample tube, a first pump for sending a sample solution to said nebulizer through said sample tube, and a second pump for sending an internal standard to said nebulizer, the sample-introducing apparatus for ICP analysis further comprising a controller for automatically stopping said first pump at a change of sample solution.

The invention provides a method of making ICP analysis, comprising a step of introducing a plurality of sample solutions in succession through a sample tube to a nebulizer formed so as to suck a sample solution by means of carrier gas supplied, the method comprising a step of automatically stopping carrier gas or automatically reducing the flow rate of carrier gas at a change of sample solution.

The invention provides a method of making ICP analysis, comprising a step of sending a plurality of sample solutions in succession to a nebulizer through a sample tube by a first pump, and sending an internal standard to the nebulizer by a second pump, the method comprising a step of automatically stopping said first pump at a change of sample solution.

A sample-introducing apparatus for ICP analysis includes a sample tube for conveying a sample solution to be analyzed, and a nebulizer formed so as to be connected to the sample tube and suck a sample solution by means of carrier gas supplied. The sample tube is dipped in a sample solution in a vessel, and the sample solution is sucked into the nebulizer by means of negative pressure generated by supplying carrier gas to the nebulizer. The nebulizer atomizes the sample solution and sends the atomized solution to ICP. ICP is plasma generated by induced-coupling, and evaporates, decomposes, atomizes, and ionizes the aerosol-like sample solution made at the sample-introducing portion. In the case of an ICP-OES, emission strengths of elements included in the sample are analyzed by spectroscopy using these atoms and ions. In the case of an ICP-MS, ionic strengths of elements included in the sample are measured with a mass spectrometer. These analytical apparatuses are widely used for element analysis of an ultra-high purity reagent for semiconductors, or, of an environmental sample such as river water or running water. In this connection, a self-priming nebulizer using negative pressure generated by means of carrier gas is considerably used particularly for analysis of a semiconductor to which a fixed quantity in a low concentration is required and which is apt to be avert to contamination.

According to one aspect of the present invention, a self-priming sample-introducing apparatus for ICP analysis as described above includes a controller for automatically stopping carrier gas or automatically reducing the flow rate of carrier gas at a change of sample solution. This can be realized by, for example, controlling the microprocessor so as to automatically close the control valve of the massflow controller or reduce the flow rate at a change of sample solution. When an ICP analytical apparatus is combined with an auto-sampler, control can be realized by introducing such a sequence as to stop carrier gas or reduce the flow rate of carrier gas before the sample tube is pulled up from one sample solution, and to restore carrier gas after the sample tube is dipped in another sample solution, into the control program of the ICP analytical apparatus main body which also controls the auto-sampler. For not stopping carrier gas but reducing the flow rate of carrier gas, control is made such that air is not substantially sucked into the nebulizer by the negative pressure generated by means of the carrier gas.

Another aspect of the present invention relates to a sampling apparatus for an ICP analytical apparatus including a sample tube for conveying a sample solution, a nebulizer connected to the sample tube, a first pump for sending a sample solution to the nebulizer through the sample tube, and a second pump for sending an internal standard to the nebulizer. An internal standard method is a method by which an element such as Y, Co, Sc, Be, or Tl is added to a standard solution, the ratio between the emission strength of an element to be measured and the emission strength of an internal standard element is plotted for the concentration of the element to be measured to make a calibration curve, and then the emission strength ratio of the internal standard element added to a sample solution in a similar manner is measured, and thus quantitative determination of the measured element is carried out. In the present invention, control is made such that the first pump is automatically stopped at a change of sample solution. In general, the mixture ratio between a sample to be measured and an internal standard is considerably large like the order of 20:1 while when air is sucked into a sample solution at a change of sample solution, the balance of the mixture is significantly disturbed, and thereby much time is required until the mixture reaches a state of balance after the measurement is restarted. In the present invention, the balance of the mixture is not disturbed as far as possible by automatically stopping the pump at a change of sample solution so that the signal of an internal standard is stabilized.

Also in this case, an ICP analytical apparatus can be combined with an auto-sampler, where like the above case as described, such a sequence as to stop the first pump before the sample tube is pulled up from one sample solution and to restore the first pump after the sample tube is dipped in another sample solution can be introduced into the control program. In an ordinary case, a change of sample solution is a change from a sample solution to be analyzed to another sample solution to be analyzed, a change from an analyzed sample solution to a cleaning solution, and/or a change from a cleaning solution to a sample solution to be analyzed.

According to the present invention, control is made such that air is not sucked into a self-priming nebulizer by automatically stopping carrier gas or automatically reducing the flow rate of carrier gas at a change of sample solution, thereby solving the problem that self-priming stops due to sucking of air. Furthermore, when an internal standard is added online using a pump, automatically stopping the pump at a change of sample solution solves, as expected, the problem that the signal of the internal standard is disturbed for a long time due to sucking of air, thereby the analysis time reduction can be achieved.

An embodiment of the present invention will be described using FIG. 1 and FIG. 2. At first, when the nubulizer 1 is a self-priming type as shown in FIG. 1, carrier gas such as argon is conveyed through a pipeline 9 from a cylinder not shown in the figure by a massflow controller 8. Then, negative pressure is generated at the end of the nebulizer 1, into which a sample 3 is sucked by means of the negative pressure. The sample 3 is atomized by the nebulizer and then introduced from the following spray chamber to the plasma torch 4. Next, the sample aerosol is atomized and ionized by high-temperature plasma, and detected by a following optical emission spectrometer (OES) or mass spectrometer (MS) not shown in the figure. As described above using FIG. 1, when the sample tube 2 is simply moved at a change of sample, many liquid phase/gas phase interfaces are formed in the tube due to sucking of air. There is a problem that if the number of the interfaces becomes large like, for example, 20 to 30, the flow resistance to self-priming becomes large and thereby self-priming stops. In particular, in the field of semiconductor sample where it is typically adopted to send a solution by self-priming, this problem has been reported in many cases.

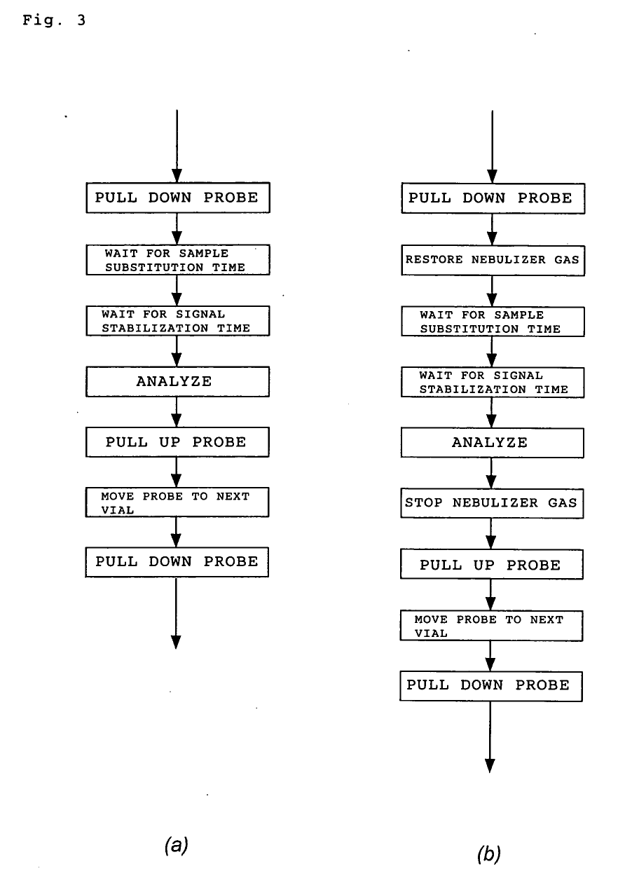

In the example of FIG. 1, the nebulizer 1 has a single suction nozzle, where a sample tube 2 is connected. After the measurement of the sample 3 is finished and before the sample tube 2 is pulled up from the sample 3, the massflow controller 8 is controlled to stop carrier gas. In this connection, the massflow controller 8 is controlled, along with massflow controllers for controlling flow paths of other gases such as cooling gas and auxiliary gas, by a microprocessor or the like not shown in the figure. Once the carrier gas has been stopped, the sample tube 2 does not suck air before the sample tube 2 is dipped in the cleaning solution 6. Thus, the problem is solved that the flow resistance of the tube becomes large due to sucking of air, thereby stopping self-priming. FIG. 3 partially shows a control sequence performed when the configuration of FIG. 1 is applied to an auto-sampler. FIG. 3(a) shows a conventional sequence, and FIG. 3(b) shows a sequence conforming with the present invention. By incorporating a procedure of stopping carrier gas, i.e., nebulizer gas and restoring it, in the conventional sequence, the present invention can be easily realized with an auto-sampler.

In the example of FIG. 2, as generally used in the analysis of an environmental sample, an element such as yttrium, for example, is added online, as an internal standard, to a sample by a pump 5′. At a change of sample solution, the pump 5 for sending a sample solution to the nebulizer 1 is automatically stopped. The pump 5′ may be stopped or not stopped, and either will do for solving this problem. However, in consideration of reducing the consumption of the internal standard solution or stabilizing the concentration ratio between the internal standard solution and a sample, the pump 5′ is preferably stopped along with the pump 5. FIG. 2 shows two independent pumps 5 and 5′. However, for a peristaltic pump usually used, it is generally designed that a double tube is set on one pump by which a sample solution and an internal standard solution are sent. In this case, the sample solution and the internal standard solution are both automatically stopped. This control sequence can also be easily realized with an auto-sampler as with the sequence of FIG. 3(b).

### Embodiment 1

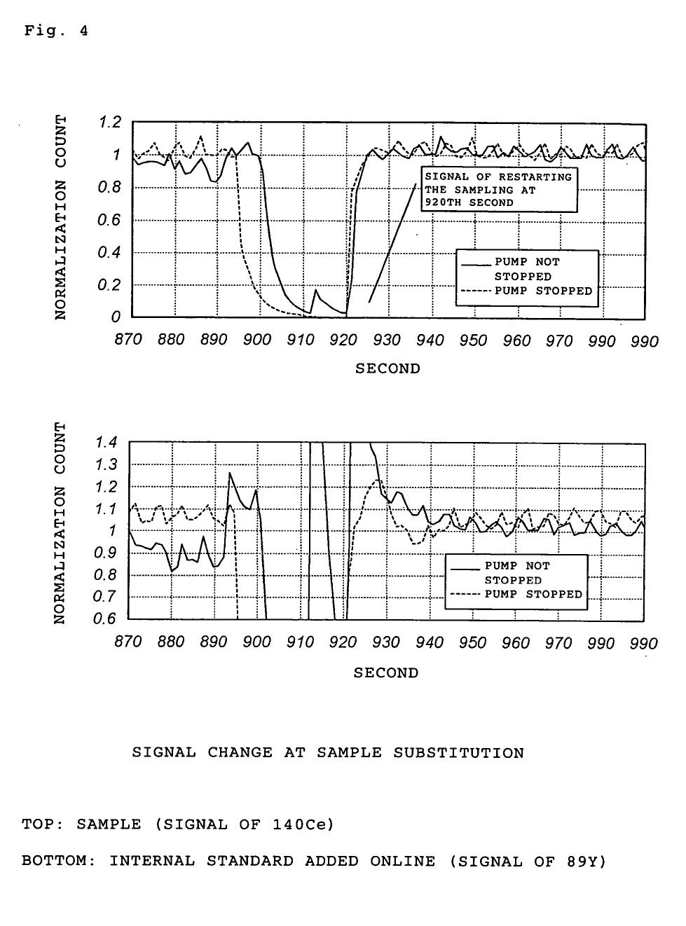

FIG. 4 is an experimental result obtained when an internal standard is added online as shown in FIG. 2, showing that an internal standard signal is stabilized more quickly when the pump 5 is stopped so as not to suck air at a substitution of sample solution by changing. When sample solutions A and B having the same concentration of cerium of 10 ppb are used, and a sample solution to be measured is changed from A to B, a change in the signal of cerium and a change in the signal of an internal standard (yttrium) are compared in both cases of stopping and not stopping the pump 5 at the change of sample solution. After the substitution of sample solution, the signal of cerium starts to increase after about 920 seconds and stabilizes in about 5 seconds. These signal changes are not different between stopping and not stopping the pump 5. However, the signal of the internal standard significantly fluctuates if the pump 5 is not stopped, and it will take longer time before the signal stabilizes again.

What is claimed is:

1. A sample-introducing apparatus for ICP analysis, comprising a sample tube for conveying a sample solution, and a nebulizer connected to the sample tube and formed so as to suck a sample solution by means of carrier gas supplied, the sample-introducing apparatus for ICP analysis further comprising a controller for automatically stopping carrier gas or automatically reducing the flow rate of carrier gas at a change of sample solution.

2. The sample-introducing apparatus for ICP analysis of claim 1, wherein said controller pulls up the sample tube from one sample solution after automatically stopping carrier gas or automatically reducing the flow rate of carrier gas, and automatically restores carrier gas after dipping the sample tube in another sample solution.

3. A sample-introducing apparatus for ICP analysis, comprising a sample tube for conveying a sample solution, a nebulizer connected to said sample tube, a first pump for sending a sample solution to said nebulizer through said sample tube, and a second pump for sending an internal standard to said nebulizer, the sample-introducing apparatus for ICP analysis further comprising a controller for automatically stopping said first pump at a change of sample solution.

4. The sample-introducing apparatus for ICP analysis of claim 3, wherein said controller pulls up the sample tube from one sample solution after automatically stopping said first pump, and automatically restores said first pump after dipping the sample tube in another sample solution.

5. The sample-introducing apparatus for ICP analysis of claim 1, wherein said change of sample solution is selected from the group consisting of a change from a sample solution to be analyzed to another sample solution to be analyzed, a change from a sample solution to be analyzed to a cleaning solution and a change from a cleaning solution to a sample solution to be analyzed.

6. The sample-introducing apparatus for ICP analysis of claim 1, which is arranged to combine with an auto-sampler.

7. A method of making ICP analysis, comprising a step of introducing a plurality of sample solutions in succession through a sample tube to a nebulizer formed so as to suck a sample solution by means of carrier gas supplied, the method comprising a step of automatically stopping carrier gas or automatically reducing the flow rate of carrier gas at a change of sample solution.

8. The method of claim 7, wherein the change of sample solution is made by comprising steps of pulling up said sample tube from one sample solution after automatically stopping carrier gas or automatically reducing the flow rate of carrier gas, and automatically restoring carrier gas after dipping the sample tube in another sample solution.

9. A method of making ICP analysis, comprising a step of sending a plurality of sample solutions in succession to a nebulizer through a sample tube by a first pump, and sending an internal standard to the nebulizer by a second pump, the method comprising a step of automatically stopping said first pump at a change of sample solution.

10. The method of claim 9, wherein the change of sample solution is made by comprising steps of pulling up the sample tube from one sample solution after automatically stopping said first pump, and automatically restoring said first pump after dipping the sample tube in another sample solution.
